(19) United States
(12) Patent Application Publication
(10) Pub. No.: US 2014/0344375 A1
(43) Pub. Date: Nov. 20, 2014

(54) Systems and Methods for Wireless Activity Monitoring with Notifications

(71) Applicant: ConnecteDevice Limited, Wanchai (HK)

(72) Inventors: Peter Hauser, Kirkland, WA (US); Henri-Nicolas Olivier, Happy Valley (HK)

(21) Appl. No.: 14/253,231

(22) Filed: Apr. 15, 2014

Related U.S. Application Data
(60) Provisional application No. 61/825,398, filed on May 20, 2013.

(51) Int. Cl. H04L 12/58; G06F 3/16; G06F 3/01

(52) U.S. Cl. CPC H04L 51/04; G06F 3/016; G06F 3/167
USPC 709/206

(57) ABSTRACT

Systems and methods for providing notifications to a user include a first computing device associated with a user and having one or more event indicators that present notifications of events to a user, a second computing device in wireless communication with the first computing device, the second computing device including information about a current status of the user; and a notification filtering engine in communication with the first computing device to modify the notifications of the events presented by the first computing device in response to the current status of the user.

### CROSS SECTION TO RELATED APPLICATIONS

This application claims priority to and benefit of U.S. Provisional Patent Application No. 61/825,398 (filed May 20, 2013), which is incorporated here by reference in its entirety.

### FIELD

This disclosure relates to activity monitoring systems and methods and, more particularly, to systems and methods for modifying user notifications based on a current activity or context of a user.

### BACKGROUND

An entire generation exists today that has never experienced life without a mobile phone. This generation, sometimes called the “Connected Generation” or “Generation C” is always in touch, even when on the move, on account of the proliferation of smart phones, the internet, tablet computers, laptops, etc. More recently social networks have erupted, with the predominant social network sites having over 800 Million subscribers.

Therefore, some people have become dependent upon immediate access to their social networks, and mobile computing platforms have become more and more prevalent. For example, some teenagers text constantly, sending over 10,000 texts a month. Other people spend more time on their social network pages than they do watching television. These people want to know immediately when something occurs in their social networks or when they receive a text so that they can respond.

Devices—such as smart watches, connected music players (e.g. iPod Touch and iPod Nano devices), smartphones, tablet computers, and eBook readers—have evolved to address this need. Most are connected directly to the internet via WiFi links or via 3G or 4G networks. Some may use Bluetooth wireless technology to extend mobile phone notifications to a smart watch or some other accessory.

### SUMMARY

A system for providing notifications of events to a user includes a first computing device associated with a user and having one or more event indicators that present notifications of events to a user, a second computing device in wireless communication with the first computing device, the second computing device including information about a current status of the user; and a notification filtering engine in communication with the first computing device to modify the notifications of the events presented by the first computing device in response to the current status of the user.

A method for providing notifications to a user includes detecting, by a first computing device, the current activity of a user; receiving, by a second computing device, notification of an event; associating, by the second computing device, a notification priority with the event based on a look-up table or formula that includes the type of event and a type of activity of the user; wirelessly transmitting data including the type of event and the notification priority from the second computing device to the first computing device; and providing, by the first computing device, an indicator of the event having one or more attributes based on the received type of event and notification priority.

### BRIEF DESCRIPTION OF THE DRAWINGS

FIG. 1 is a block diagram of a system for providing notifications to a user.

FIG. 2 is a block diagram of a device for providing notifications to a user.

FIG. 3A and FIG. 3B are pictorial diagrams of the face of a watch for providing notifications to a user.

FIG. 4 is a block diagram of a computing device.

FIG. 5 is a flow diagram of a method for providing notifications to a user.

FIG. 6 is a flow diagram of a method for entering notification preferences.

### DETAILED DESCRIPTION

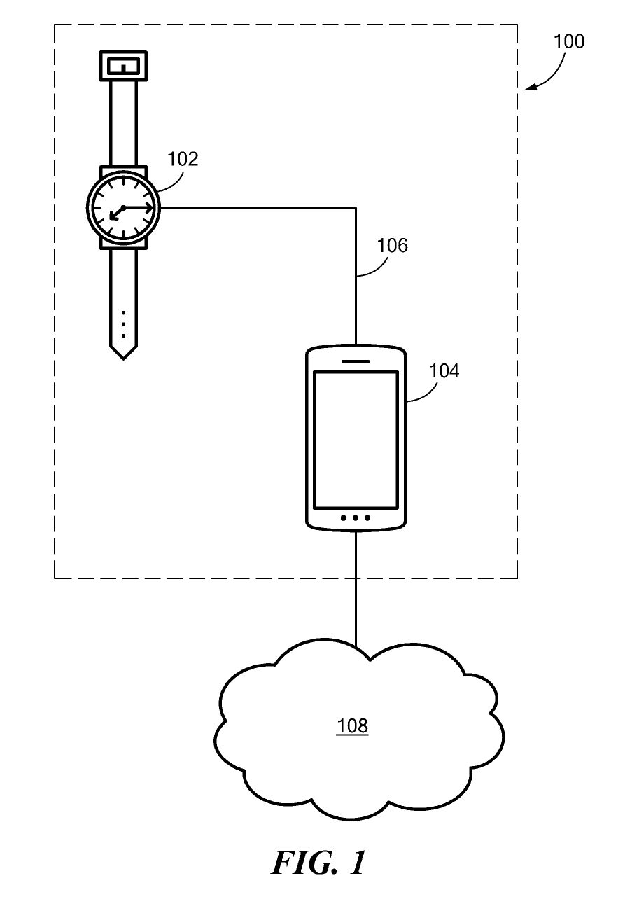

FIG. 1 is a block diagram of a system 100 for providing notifications to a user. Various aspects of system 100 may be described in co-pending U.S. patent application Ser. No. 13/862,801 (filed Apr. 15, 2013 and owned by the assignee of this application), which is incorporated here by reference in its entirety.

System 100 includes a first computing device (e.g. watch 102) and a second computing device (e.g. mobile phone 104). The first computing device may be a personal computing device that may often be kept in close proximity to a user. In embodiments, the first computing device may be worn by the user. Although shown as a watch 102 (and referred to here as a watch 102), the first computing device may be a brooch, pendant, a pin, a key-chain, wristband, belt, a mobile phone, or any other type of device that can be worn or kept in close proximity to a user. In an embodiment, the first computing device is a watch 102 that includes a processor, as will be discussed below.

In embodiments, the first computing device may include features that can notify the user of an event. These notifications may include audible notifications such as a signal from a speaker, buzzer, etc.; visual notifications from an LED, display screen, etc.; and/or tactile notifications from a vibration element or the like.

The second computing device (i.e. mobile phone 104) may also be kept in close proximity to the user. Although shown as a mobile phone 104 (and referred to here as mobile phone 104), the second computing device may be any type of computing device that can execute software applications. These include, but are not limited to: laptops, tablets, mobile phones, desktop computers, etc. in embodiments, the second computing device may include a processor and or hardware storage device, such as a hard drive or memory. Software instructions may be stored on the hardware storage device. When executed by the processor, the instructions may cause the second computing device to perform various operations, such as those that will be described below.

Mobile phone 104 and watch 102 may be in communication via network connection 106. Thus, mobile phone 104 and watch 102 each may include wired or wireless network transceivers. In embodiments, network connection 106 is a wired or wireless communications network. In particular, because both mobile phone 104 and watch 102 may be used in relatively close proximity to each other, network connection 106 may be a personal area network such as a Bluetooth® network or Low Energy Bluetooth network.

Mobile phone 104 may also include a network adapter for communication with network 108. Network 108 may be any type of network from which mobile phone 104 can receive an event, including but not limited to: a local area network; a wide area network; a cellular network; a cellular data network such as a 3G, 4G, or other cellular data network. Network 108 may be an internet, or may be connected to the internet to provide mobile phone 104 with Unmet access. Although not shown, watch 102 may have a network connection to network 108 or another network as well.

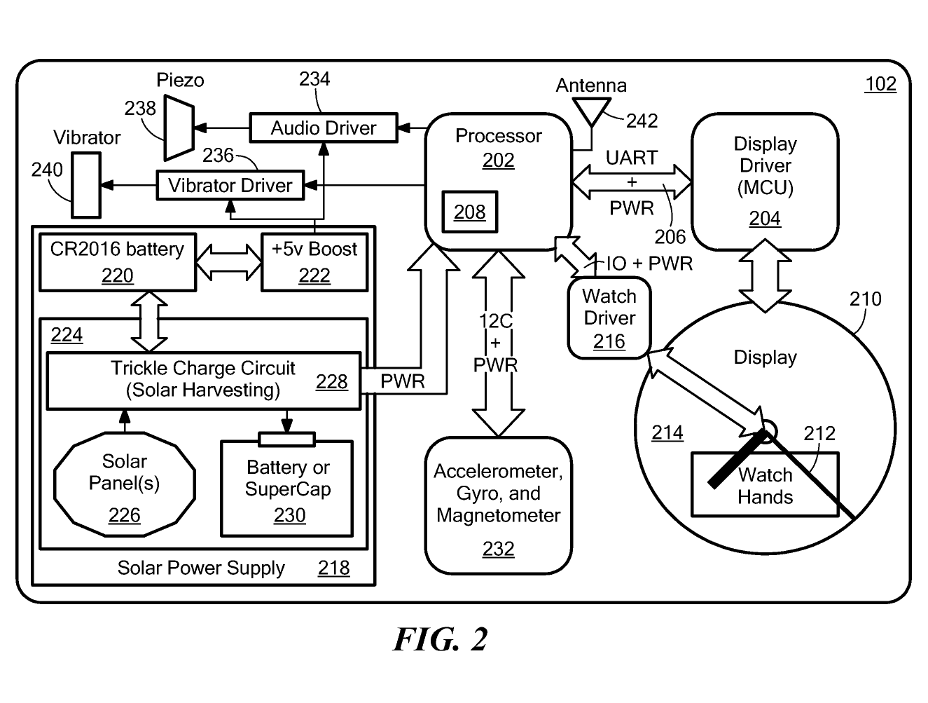

Turning now to the next figure, FIG. 2 shows a block diagram of watch 102. As noted above, watch 102 may be (or can be substituted with) any type of computing device that can provide a notification to a user.

Watch 102 includes a processor 202 in communication with display driver circuit 204 via display bus 206. As shown, display bus 206 may be a UART bus and may include power lines. However, display bus 206 may be any type of bus capable of providing communication between processor 202 and 204.

In an embodiment, processor 202 may include a hardware storage device, such as memory 208. Memory 208 may contain software instructions which, when executed by processor 202, may cause processor 202 to perform some or all of the features and functions described in this document with respect to watch 104. In embodiments, processor 202 may be a Bluetooth® or Bluetooth low energy processor, such as a CC2541 made by Texas Instruments® Inc., or an nRIF51855 processor made by Nordic Semiconductor® LLC.

As another example, processor 202 may be a custom circuit, a general purpose processor, a specialized processor, a microprocessor, a microcontroller, or any type of processor or circuit.

Display driver circuit 204 is coupled to display 210 control display 210. Display 210 is shown as a watch face having watch hands 212 and a display area 214. In other embodiments, if the first computing device is not a watch, display 210 may be a screen or other type of display.

In an embodiment, display area 214 is an electrophoretic display (e.g. a so-called e-ink display). In another embodiment, display area 214 is an LCD display. Watch hands 212 may be physical watch hands coupled to a motor or may be virtual watch hands displayed as elements of display area 214. A watch driver circuit 216 controls watch hands 212 by controlling a motor or other mechanical mechanism to move watch hands 212 if watch hands 212 are physical watch hands, or by controlling how watch hands 212 are displayed on display 210 if watch hands 212 are displayed watch hands. In another embodiment, watch 102 may have a digital readout instead of or in addition to watch hands 212.

A power circuit 218 provides power for watch 102. Power circuit 218 may include a battery 220 and a voltage regulator 222. Voltage regulator 222 may be a boost regulator as shown, a buck regulator, or any other type of voltage regulator to provide power for watch 102.

Power circuit 218 may also include a solar charging circuit 224 that can charge battery 220 via solar power. The solar charging circuit 224 can include one or more solar panels 226, a trickle charge circuit 228, and a battery or capacitor 230.

Watch 102 may also include a sensor module 232, which may include one or more sensors to determine a current activity of the user. For example, sensor module 232 may include an accelerometer, a gyroscope, a magnetometer, a GPS receiver, a heart rate sensor to sense the heart rate of the user, a temperature sensor to sense the ambient temperature and/or the skin temperature of the user, a moisture sensor to sense humidity in the air and/or a level of sweat on the user's skin, etc.

Watch 102 may use the sensors in sensor module 232 to determine or to assist in determining the current activity of the user. For example, the accelerometer may be used to detect whether the user is walking, running, riding in a car, or performing other types of activity. The gyroscope may be used to determine, for example, whether the user is moving, moving in a straight line, turning, etc. The magnetometer may be used, similar to a compass, to determine the user's direction of travel (e.g. North, South, East, West).

an embodiment, watch 102 may send data from the sensors to the phone 104. The phone 104 may use sensor data from watch 102, as well as sensor data from phone 104 to monitor the activity of the user. For example, the phone 104's sensors (which may include any or all of the same types of sensors of watch 102, as well as other sensors such as a GPS receiver, etc.), may suggest that the phone is currently at rest (e.g. not accelerating, nor decelerating) on a table, in a bag on the floor, in a locker, etc. At the same time, the watch's accelerometer may indicate that the watch is accelerating and decelerating in a consistent rhythm and at an intensity suggesting that the user may be running. Such sensor data may be interpreted to mean that the user is on a treadmill or other stationary exercise equipment and is performing vigorous activity.

By leveraging all available data sources including the watch sensors, an app that is running on the phone 104 may interpret the additional context received by the watch to fill the gaps in phone activity monitoring data. Established algorithms that distinguish between activities based-on phone sensor data as well as wrist-worn device sensor data (e.g. walking from running) may be used, and the resultant data may be compared by the app to best isolate the “actual” activity that currently applies to the user. Furthermore, should the phone 104's activity data match the activity data observed by the watch, for example if the phone 104's sensors and the watch 102's sensors both indicate the user is exercising, driving, walking, etc., then the watch sensors may be turned off by the app executing on phone 104 (e.g. by sending an instruction to turn off the sensors via wireless transmission) in order to conserve watch power.

In another example, the user may have placed their phone 104 on a night stand to charge, and is wearing the watch 102 while sleeping in bed. The app may thus interpret the phone's current status (e.g. charging and stationary with the phone's face pointing upwards) as being out of direct contact with the user, and turn on the watch 102 sensors to detect the user's activity level. The app may thus assess the activity of the user during the night and later provide feedback on the level of restfulness experienced by the user, while also determine the optimal time to forward notifications that have been pending on the phone 104 overnight.

In meeting situations, the watch 102 may be worn by the user in the boardroom. Once again, the phone 104 may be left on the table while the user is presenting and pacing at the front of the room. The watch 102 may detect the user's movements via the onboard sensors as well as the distance from the phone as measured by the Receiver Signal Strength indication (RSSI). This data may be communicated to the phone 104 such that the app running on the phone 104 may make decisions as to whether or not to interrupt the user with notifications on the watch 102.

Watch 102 also includes one or more notification circuits, such as audio driver circuit 234 and vibrator driver circuit 236. Audio driver circuit 234 may be a circuit coupled to a piezoelectric device 238, a speaker, or another type of electronic device that can create auditory sounds when activated by audio driver circuit 234. When activated, piezoelectric device 238 may create a beep, buzz, or other audible alert that the user can hear.

Vibrator driver circuit 236 is coupled to a vibrator device 240. When activated, vibrator device 240 may vibrate to create a tactile sensation that the user can feel.

Audio driver circuit 234 and vibrator driver circuit 236 are coupled to processor 202, which may control audio driver circuit 234, vibrator driver circuit 236, piezoelectric device 238 and vibrator device 240.

Although not shown, watch 102 may include an LED driver circuit coupled to one or more LEDs activated by the LED driver circuit. Processor 202 may be coupled to the driver circuit to control activation of the LEDs, to provide a visible notification to the user. The processor may turn the LEDs on and off, blink the LEDs, etc.

The LED driver circuit of the watch 102 may also be used to light the back of the LCD display 214 or provide additional level of visibility to the user for notifications.

Display 210 may also provide visible notifications, such as an erratic or unexpected movement of watch hands 212, adjustment of the watch hands 212 to a new fixed position that may coincide with an LED, lighting of an icon in display 214, etc.

Watch 102 may also include an antenna 242. Antenna 242 may be a wireless communication antenna capable of wirelessly communicating with other devices via electromagnetic radiation. In an embodiment, antenna 242 is a Bluetooth antenna or Bluetooth low energy antenna that can communicate with other Bluetooth devices over a Bluetooth wireless communication link.

The antenna 242 may be a printed antenna, chip antenna, wired antenna, a conductive film on the display glass, a metal component that is affixed to or part of the watch case, etc.

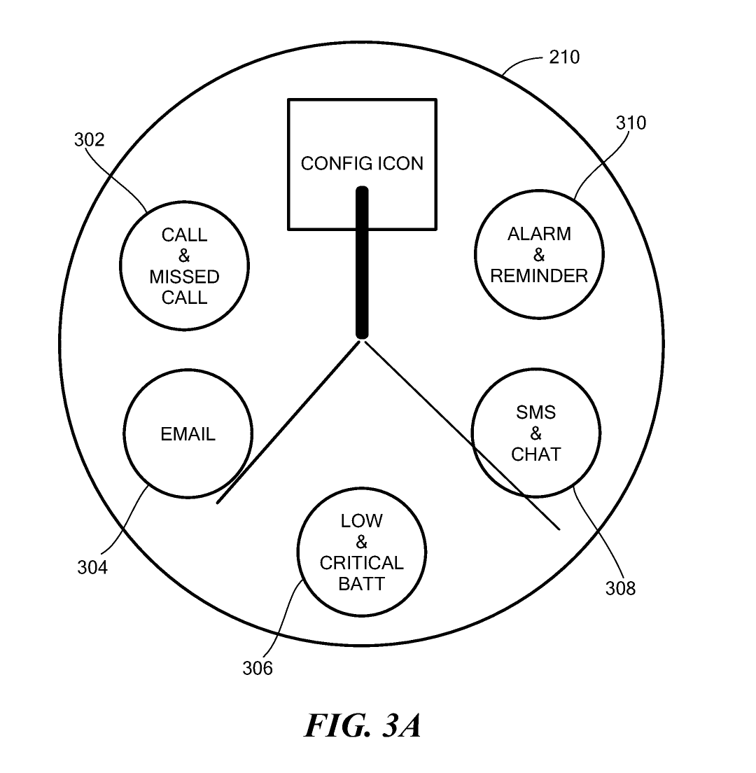

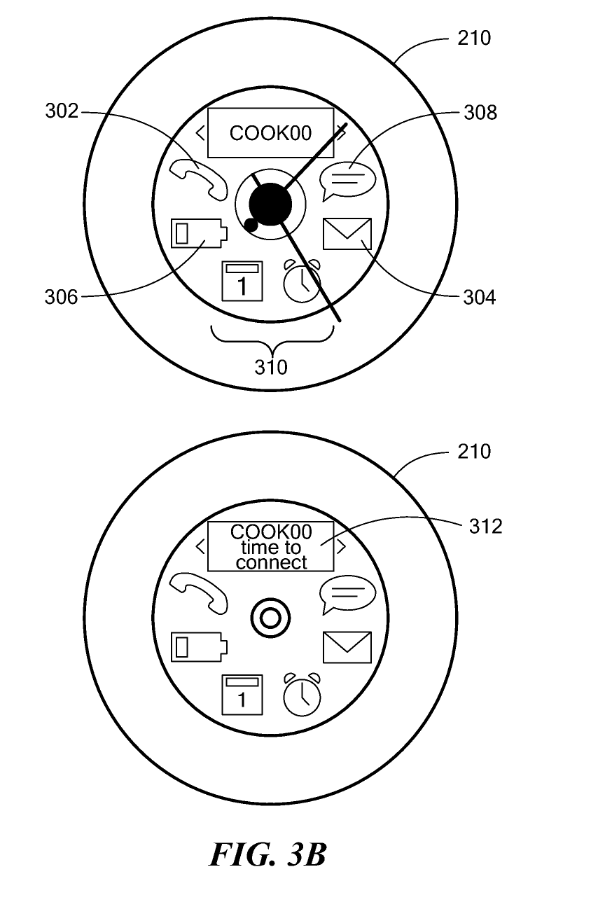

Turning now to FIG. 3A and FIG. 3B, display 210 may include one or more icons to notify a user of one or more events. In an embodiment, display 210 includes a telephone call icon 302 to notify the user of a call, a missed call, a voicemail, etc.; an email icon 304 to notify the user of an email; a battery level icon to notify the user of a low or critical battery level; a social messaging icon 306 to notify the user of a social messaging message; and an alarm icon 308 to notify the user of an alarm condition, a meeting, a reminder, etc.

In embodiments, icons 302-310 are always visible on display 210 and light up or blink to inform the user of an event. In other embodiments, icons 302-310 are usually not shown by display 210. When an event is received, display driver circuit 204 and processor 202 may cause the icons to become visible on display 210.

Icons 302-310 may be configured to display an event and a priority of the event. For example, if a regular priority email is received, email icon 304 may become visible, may light up, may display a particular color, etc. If a high priority email is received, email icon 304 may blink or may change do a different color, or the like.

FIG. 3B is another view of display 210. In FIG. 3B, icons 302-310 have been re-arranged and are shown with symbols. For example, email icon 304 is shown in a bottom-right area as an envelope icon.

In another embodiment of the invention, a mix of icons 302-310 and text 312 may be displayed to communicate alerts. In this embodiment the icons and text may work together to communicate more detail about the event, or to provide more information as to its priority level.

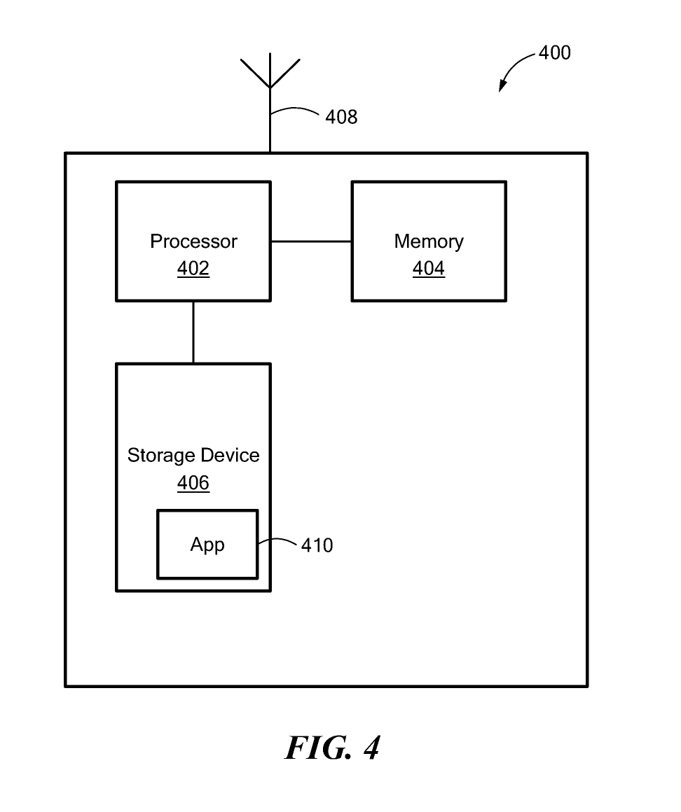

Turning to FIG. 4, computing device 400 may be the same as or similar to the second computing device (i.e. phone 104) in FIG. 1. Computing device 400 may be a mobile device such as a phone or tablet, a laptop, a desktop, etc.

Computing device 400 includes a processor 402 coupled to a memory 404 and a hardware storage device 406. Processor 402 may be a general purpose processor, a mobile processor, microcontroller (MCU), a custom ASIC, etc. Memory 404 may be a volatile memory such as a RAM. Hardware storage device 406 may be a nonvolatile memory such as a hard drive a, a FLASH drive, a ROM, an EEPROM, or the like.

Computing device 400 may includes a transceiver 408. In an embodiment, transceiver 408 is a wireless transceiver capable of communicating with watch 102 via a wireless communication link. Transceiver 408 may, for example, be a Bluetooth or Bluetooth low energy transceiver. In an embodiment, processor 402 may be a specialized communication processor such as a Bluetooth processor. In other embodiments, processor 402 may be a general purpose processor and computing device 400 may include specialized circuitry or computer chips to implement wireless communication over transceiver 408. For example, processor 402 may be in communication with a Bluetooth processor or chipset that drives Bluetooth communication via transceiver 408.

Computing device 400 may include an application, or “app”, 400. App 400 may be a software application comprising a set of instructions, which, when executed by processor 402, may cause processor 402 to perform operations and provide features as described herein. App 410 may also reside, in whole or in part, in memory 404 during operation of computing device 400.

Although not shown, computing device 400 may also include a display, such as a phone display or monitor. App 410 may include a graphical user interface (GUI) that can be shown on the display so a user can interact with app 410.

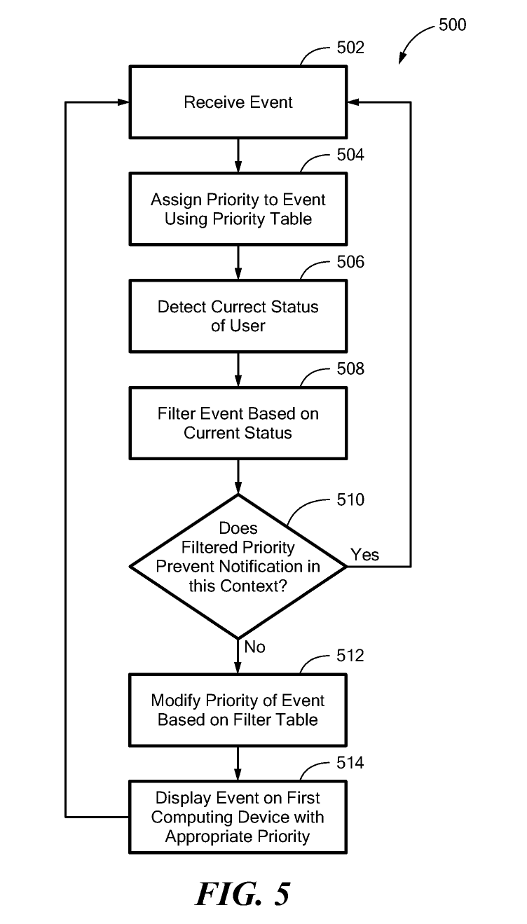

Referring now to FIG. 5 and also to FIG. 1, a process 500 for notifying a user of an event may be implemented by a first computing device (e.g. watch 102), a second computing device (e.g. phone 104), or both. In block 502, an event is received by phone 104. The event may be an email; a telephone call; a social alert; a battery level event such as a battery level going below or above a predetermined level; a news, weather, or stock alert; an appointment; a representation of the current activity of the user; a time of day; a location of the user, a physical activity type or level of the user; a notification of a sporting event, score, a reward, a marketing notification, etc.; an RSS feed message; a state of wireless connectivity; a direction of movement of the user, etc.

In block 504, the system assigns a priority to the event using an event priority table. In this example, events may be assigned one of three priority levels: High (“H”), Medium “M”), and Low (“L”). Of course, other priority levels may be used. In another embodiment, any number of priority levels may be used.

The priority table may be set by a user using app 410 on computing device 400. In embodiments, the user may use a GUI of app 410 to associate a priority level with each type of notification. For example, the user may set incoming emails to receive medium priority, and incoming telephone calls or texts to receive high priority.

The following example priority table shows priorities associated with certain events. In an embodiment, the priority assigned from the priority table may act as a default priority, which may be modified in subsequent operations. The priority table may comprise data that is stored in a hardware storage device and accessed by app 410.

TABLE 1

| Event | Priority |
|---|---|
| Email | Medium |
| Telephone Call | High |
| Text Message | High |
| News Alert | Low |

For ease of illustration, an abbreviated list of events is shown in Table 1. Any other type of event may be listed in the priority table as well.

Once the initial priority has been assigned to the event, the system 100 may filter or modify the priority based on a current status of the user. In block 506, the system may detect a current status or “context” of a user.

As noted above, watch 102 and mobile phone 104 include sensors to determine a current status of a user. For example, if a user is walking, watch 102 and/or phone 104 may use accelerometers to determine that the user is walking. Similarly, if the user is engaged in vigorous activity such as running, exercise, playing sports, etc., watch 102 and/or phone 104 may use the accelerometers to determine that the user is engaged in rigorous activity. If the user is driving, watch 102 and/or phone 104 may use GPS input such as location or current speed to determine that the user is driving. If the user is in a particular location, such as at home, at work, at predetermined quiet location, the watch 102 and/or phone 104 may use GPS input to determine that the user is at the particular location.

If the user is sleeping, then the user's phone 104 may be stationary and may be charging. The system 100 may use the watch 102 data so as to determine the quality of sleep, communicate the quality of sleep information to the phone 104, and the phone 104 may use this information to determine when to alert the user in the morning of pending events.

In addition, mobile phone 104 may include a schedule of the user to determine the user's current status. For example, the system may determine that the user is in a meeting if the calendar indicates the user has a meeting at the present time. The user may also use the calendar to define time categories for notifications. For example, the user may set the calendar to receive normal notifications during work hours, and no notifications during evening and nighttime hours. Thus the user may reduce interruptions at home while receiving notifications while at the office.

In certain circumstances, the system may determine that the user has more than one current status. For example, the user may be in a predetermined quiet location, but may also be jogging, exercising, or engaging in vigorous activity. Alternatively, according to user's calendar, the user may be scheduled to be in a meeting, but the system 100 may determine that the user is driving in heavy traffic. In such instances, the system may assign both statuses as the user's current status. Alternatively, the system can assign one of the statuses as the user's current status.

In order to handle multi-status cases, an algorithm may be used that prioritizes one status over another. In one embodiment where the user is actively driving while their calendar shows them as being “free”, for example, the user's calendar status may be superseded by the more restrictive activity status, thus disabling notifications entirely to keep the user focused on the road.

In another embodiment, the user may have predetermined that they wish to receive all notifications regardless of their activity level when in a certain location. For example, the user may wish to receive notifications to their wrist despite the high activity level recorded by the watch while playing tennis at the local country club.

Thus, the priority level may be superseded by a filtering level as determined by settings and preferences in the app.

In block 508, the system 100 may filter the event based on the current status of the user. In other words, the system 100 may modify the priority assigned to the event based on the user's status. For example, if the system determines the user is in a quiet location, the system may allow only notify the user of high priority events.

In an embodiment, a filter table, such as the following example filter table, may be used to modify the priority of the received event. The filter table may comprise data that is maintained in a hardware storage device and accessed by app 410.

TABLE 2

| CURRENT STATUS | FILTER LEVEL |
|---|---|
| Vigorous Activity | All |
| Meeting | High, Medium |
| Quiet Location | High |
| Driving | None |

As an example, if the user's current status is detected as vigorous activity, the system may allow messages with all priority levels (low, medium, and high) to be presented to the user. If the user is in a meeting, the system may only provide notification of events with High and Medium priority levels to the user. If the user is in a quiet location, the system may only provide notification of events with high priority. If the user is driving, the system may present no notifications to the user whatsoever.

In an embodiment, if the system determines that more than one current statuses apply, the system may use the more restrictive setting depending on the configuration of the app. In this condition, the app may present the option to the user to use the most or least restrictive setting, or to set custom filters.

In the example above, the system may determine that the user is, according to the calendar, in a meeting and, according to the system's sensor, driving in heavy traffic. In such a situation, the system may assign the more restrictive setting. In this case, the filtering level for driving is more restrictive than the filtering level for a meeting, so a filtering level of “none” may be applied. In other embodiments, the system may apply the least restrictive setting of the current statuses. Whether to apply the most restrictive, the least restrictive, or an average of the filter settings for the determined statuses can be set via user preferences of app 410.

In an embodiment, the user may define the filtering level for each type of current status. The user may, for example, enter a filtering level for each type of detected current status into a GUI of app 410. Table 2 is shown as an example of a filtering table. The filtering table may include additional or fewer rows as desired by the user.

Additionally or alternatively, the system 100 may modify the priority level of certain events based on user settings and/or preferences. For example, a user may specify that the priority of events should be shifted up or down under certain circumstances. In one example, a user may specify that the priority of received events should be shifted down by one level when the user's current status is one of driving. In this instance, when the user is driving, the priority of received events will be reduced by one level (e.g. from high to medium or medium to low).

Referring again to FIG. 5, in decision box 510 the system will determine whether system settings prevent notification of the event from being delivered. For example, if a low priority event is received when the user's current context is one of being in a predetermined quiet location where only high priority notifications are allowed, then the system may determine that notification of the low priority event is prohibited.

The system may store prevented events in a memory or hardware storage device of phone 104 for delivery at a later, more appropriate time. The system 100 may continuously or periodically monitor the user's current status. As the user's activity level, current activity, or other parameter that impacts filtering changes, then the app may send the stored alerts to the user, thus ensuring that the user is made aware of each event at the correct time.

For example, if the user is currently performing vigorous exercise, then upon completion of the exercise, the app may detect that the exercise has ended, and that the user is now ready to receive events, and may send the appropriate stored events to the user shortly after detecting the change in activity level.

If notification is prohibited, the system may proceed to block 502 to receive another event. If notification is not prohibited, the system may proceed to block 512. In block 512 the system may modify the priority of the event based on the filter table above and proceed to box 514.

In box 514 the system provides an indication or notification of the event to the user. For example, phone 104 may send the event and the priority level of the event to watch 102, which may notify the user as described above.

App 410 may allow the user to set the type of notification for each priority level. For example, a high priority notification may include an audible buzz, a vibration, and a visual notification on the display. A medium priority notification may include a vibration and a visual notification, but no audible buzz. A low priority notification may include only a visual notification. The user can associate any desired combination of audible, visual, and tactile notifications with different priority levels.

In addition, the user may set different types of notifications for different types of events. A high priority email may induce a specific noise, vibration and a visual notification, while a high priority text may induce a different, shorter audible notification. Similarly a medium level meeting notification may induce a very short audible notification and a vibration, while a medium priority telephone call may induce audible, tactile, and visual notifications with reminder notifications every second until the call is answered. Any combination of event types and priority levels may be used to set specific notification types.

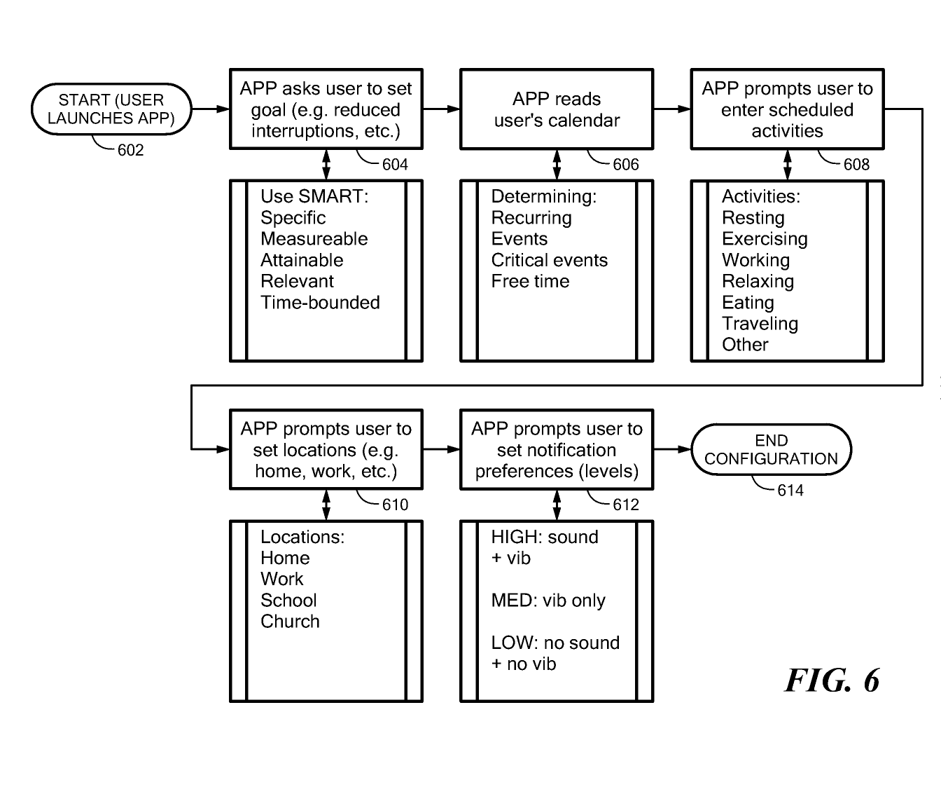

Referring now to FIG. 6, a process 600 for entering user settings into app 410 is shown. In start block 602 the user may launch app 410. In block 604, the app prompts the user to set a goal or profile (e.g. reduced interruptions, full notifications, etc.). In an embodiment, the app 410 then populates the priority table and the filter table with default values based on the profile selected by the user.

In block 606, the system 100 parses the user's calendar and identifies recurring events and meetings, critical events, and free time. The user's calendar may be used, in conjunction with the current activity level, and other filtering parameters, such as the user's current location, to determine which alerts should be filtered and sent later, and which alerts should be sent to the user's watch 102 immediately.

For example, if the user's calendar has a high priority meeting scheduled, then the user's calendar setting may restrict the notifications such that only high priority notifications are sent to the user's watch 102 by the app on the phone 104. If, however, the user's calendar shows that the time is “free”, then the other, more restrictive filtering settings such as location, or current activity level, may be used to filter the notifications to from the phone 104 to the watch 102.

In block 608 the app 410 prompts the user to enter scheduled activities, such as time for resting, exercising, working, etc. In an embodiment, these scheduled activities represent typical times that the user dedicates to the activities in question. For example, if the user typically sleeps from 11 PM until 6 AM, then the user may set their “resting” time for those hours in the app 410. Thereafter, should an alert arrive after 11 PM and before 6 am, then the alert may be stored to be sent at 6:01 AM.

If, however, the user is still asleep at 6:01 AM as determined by the activity monitors on the watch, then the app 410 may wait until after the user has awoken and demonstrated a period of activity to send the stored notifications to the user's watch.

The user may enter all of their typical schedule information into the app at the same time when setting up the app, or later after the app has already been setup using the default settings.

In block 610 the app 410 prompts the user to enter predetermined locations such as work, school, home, predefined quiet locations, etc. The user can also enter filtering levels (e.g. levels as shown in the filtering table above) to define what level of notifications to receive at each location.

In block 612, the app 410 prompts the user to enter notification preferences, for example, which notification types are associated with high priority, medium priority, and low priority events. In block 614, the app 410 terminates the configuration and populates the priority table and the filtering table with the settings entered by the user.

Having described various embodiments, which serve to illustrate various concepts, structures and techniques, which are the subject of this patent, it will now become apparent to those of ordinary skill in the art that other embodiments incorporating these concepts, structures and techniques may be used. Accordingly, the scope of the patent should not be limited to the described embodiments but rather should be limited only by the spirit and scope of the following claims.

What is claimed is:

1. A system comprising:
a first computing device associated with a user and having one or more event indicators that present notifications of events to a user;
a second computing device in wireless communication with the first computing device, the second computing device including information about a current status of the user; and
a notification filtering engine in communication with the first computing device to modify the notifications of the events presented by the first computing device in response to the current status of the user.

2. The system of claim 1 wherein the first computing device is a worn device.

3. The system of claim 2 wherein the first computing device is a watch and the event indicators are visible elements on a face of the watch.

4. The system of claim 1 wherein the notifications of events comprise one or more types of notifications chosen from the list consisting of: a notification of an email; a notification of a telephone call; a notification of a social alert; a notification of a battery level; a notification of a news, weather, or stock alert; a notification of an appointment; a notification of a current an activity of the user; a notification of a time of day; a notification of a location of the user, a notification of a physical activity type or level of the user; a notification of a sporting event; a notification of an RSS feed message; a notification of a state of wireless connectivity; and a notification of a direction of movement of the user.

5. The system of claim 1 wherein one or more of the notifications are associated with a priority level.

6. The system of claim 1 wherein the second computing device is a mobile device.

7. The system of claim 1 wherein the information about a current status of the user includes a schedule of the user.

8. The system of claim 1 wherein the second computing device includes an alert level table that defines alert preferences of the user.

9. The system of claim 1 wherein the information about a current status of the user includes an activity level of the user.

10. The system of claim 8 wherein the alert level table includes alert level preferences associated with activities of the user and/or associated with a schedule of the user.

11. The system of claim 8 wherein the alert level table is stored in a memory of the second computing device and/or in a cloud storage service.

12. The system of claim 9 wherein the notification filtering engine modifies the notifications by comparing an incoming notification to the current activity level of the user.

13. The system of claim 12 wherein the notification filtering engine modifies the notifications by comparing the incoming notification to a predefined preference in an alert level table.

14. The system of claim 1 wherein the first computing device and the second computing device communicate via a Bluetooth low-energy protocol.

15. The system of claim 1 wherein the first computing device comprises one or more sensors to determine the user's current activity and the notification filtering engine is configured to modify the notification of events based on the detected, current activity.

16. The system of claim 12 wherein the one or more sensors includes one or more of an accelerometer, magnetometer, and a GPS receiver.

17. The system of claim 15 wherein the first and/or second computing device is further configured to turn sensors in the first computing device on or off based on a correlation between activity levels monitored by the first and second computing devices, in order to optimize the power consumption of the first computing device.

18. A method comprising:
detecting, by a first computing device, the current activity of a user;
receiving, by a second computing device, notification of an event;
associating, by the second computing device, a notification priority with the event based on a look-up table or function that includes the type of event and a type of activity of the user;
wirelessly transmitting data including the type of event and the notification priority from the second computing device to the first computing device; and
providing, by the first computing device, an indicator of the event having one or more attributes based on the received type of event and notification priority.

19. The method of claim 18 wherein the first computing device is a worn device, and detecting the current activity includes monitoring, via sensors associated with the worn device, the movement, speed, and direction of the user.

20. The method of claim 18 wherein the look-up table include a schedule of the user and associating the notification priority with the event is further based on the schedule of the user.

21. The method of claim 18 wherein providing the indicator includes one or more of providing a visual indicator, providing an audible indicator, and a haptic indicator.

22. The method of claim 18 wherein the attributes of the indicator include a brightness of the indicator, a blink rate of the indicator, a volume of the indicator, and/or a level of haptic feedback of the indicator.

23. The method of claim 18 wherein further comprising deactivating sensors of the first computing device if a same current activity of the user is detected by both the first computing device and the second computing device.
